(19) United States
(12) Patent Application Publication
(10) Pub. No.: US 2014/0160608 A1
(43) Pub. Date: Jun. 12, 2014

(54) SURGE PROTECTIVE NETWORK SIGNAL PROCESSING CIRCUIT ASSEMBLY

(71) Applicant: AJOHO ENTERPRISE CO., LTD., Taipei City (TW)

(72) Inventors: Chia-Ping MO, Taipei City (TW); You-Chi LIU, Taipei City (TW)

(73) Assignee: AJOHO ENTERPRISE CO., LTD., Taipei City (TW)

(21) Appl. No.: 14/180,854

(22) Filed: Feb. 14, 2014

Related U.S. Application Data
(63) Continuation-in-part of application No. 13/544,538, filed on Jul. 9, 2012.

(51) Int. Cl. H02H 9/04

(52) U.S. Cl. CPC H02H 9/04
USPC 361/56

(57) ABSTRACT

A surge protective network signal processing circuit assembly includes a network chip, a network connector, and a processing circuit connected between the network chip and the network connector and including one or multiple two-wire channels electrically connected in parallel between the network chip and the network connector, a signal coupling capacitor electrically connected to each two-wire channel and a self-coupling AC regulator electrically connected in parallel to each two-wire channel between the network connector and the associating signal coupling capacitor and electrically connected to a ground terminal for discharging voltage surge

This application is a Continuation-In-Part of application Ser. No. 13/544,538, filed on Jul. 9, 2012, for which priority is claimed under 35 U.S.C. §120, the entire contents of which are hereby incorporated by reference.

### BACKGROUND OF THE INVENTION

1. Field of the Invention

The present invention relates to network technology and more particularly, to a surge protective network signal processing circuit assembly, which has a self-coupling AC regulator installed in each two-wire channel of the processing circuit thereof for discharging voltage surges to a ground terminal, avoiding power surge damage.

2. Description of the Related Art

With fast development of computer technology, desk computers and notebook computers are well developed and widely used in different fields for different applications. It is the market trend to provide computers having high operating speed and small size. Further, network communication technology brings people closer together, helping people to gather information about living, learning, working and recreational activities. By means of network communication, people can communicate with one another to send real time information, advertising propaganda or e-mail. Further, through the internet, people can search information, send instant messages, or play on-line video games. The development of computer technology makes the relationship between people and network unshakable and inseparable.

In a network, cable or wireless interference means may be selectively used for data transmission. The technology of cable connection for network application needs to use network connectors. With the development of network applications, the data transmission capacity is greatly increased. In order to satisfy user's demands, network connection speed has been greatly improved from the rate of 10 Mbps up to 100 Mbps or 1 Gbps. The advanced fiber optic network can support 10 Gbps. However, if a network signal line gets struck by a lightning, the unusual electrical surge from the lightning strike can affect signal transmission stability, interrupting the connection, or causing damage to the network chip, circuit board or other connected electronic components or devices (computer, router, etc.). Computer networks are categorized by their scope or scale. The usually said categories of networks are LAN (local area network), MAN (metropolitan area network), WAN (wide area network). The most well-known WAN is the internet. When linking a network signal, or uploading or downloading network data, external electromagnetic noises and internal surging noises (such as lightning strikes) can affect signal transmission stability. Therefore, it is necessary to install filter devices in network connectors for removing noises, electromagnetic waves and voltage surges. However, the filter devices of conventional network connectors cannot effectively remove all instantaneous high voltage surges caused by lightning strikes to prevent damage to the network chip and other connected electronic components.

Therefore, it is desirable to provide a network processing circuit that eliminates the aforesaid problems.

### SUMMARY OF THE INVENTION

The present invention has been accomplished under the circumstances in view. It is therefore the main object of the present invention to provide a surge protective network signal processing circuit assembly, which uses a self-coupling AC regulator in each two-wire channel of the processing circuit thereof for discharging voltage surges to a ground terminal, avoiding power surge damage.

To achieve this and other objects of the present invention, a surge protective network signal processing circuit assembly of the present invention comprises a network chip, a network connector, and a processing circuit connected between the network chip and the network connector. The processing circuit comprises at least one two-wire channel electrically connected in parallel between the network chip and the network connector, a signal coupling capacitor electrically connected to each two-wire channel, and a self-coupling AC regulator electrically connected in parallel to each two-wire channel between the network connector and the associating signal coupling capacitor. Further, each self-coupling AC regulator is electrically connected to a ground terminal for discharging voltage surges.

Further, each self-coupling AC regulator comprises an iron core, and a winding wound round the iron core. The winding has two opposing sides respectively electrically connected to the two wires of the respective two-wire channel.

### BRIEF DESCRIPTION OF THE DRAWINGS

FIG. 1 is a block diagram of a surge protective network signal processing circuit assembly in accordance with the present invention.

FIG. 2 is a circuit diagram of the processing circuit of the surge protective network signal processing circuit assembly in accordance with the present invention.

FIG. 3 is an alternate form of the block diagram of the surge protective network signal processing circuit assembly in accordance with the present invention.

FIG. 4 is a circuit diagram of a self-coupling AC regulator in accordance with the present invention.

### DETAILED DESCRIPTION OF THE PREFERRED EMBODIMENT

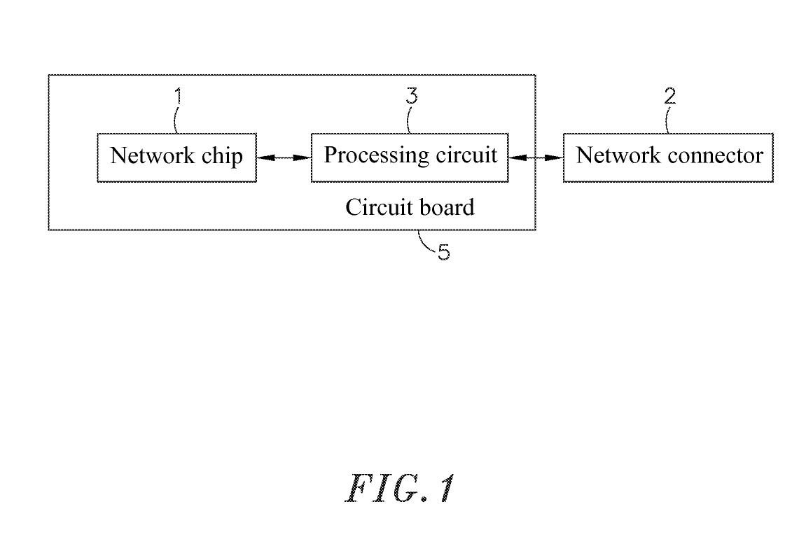

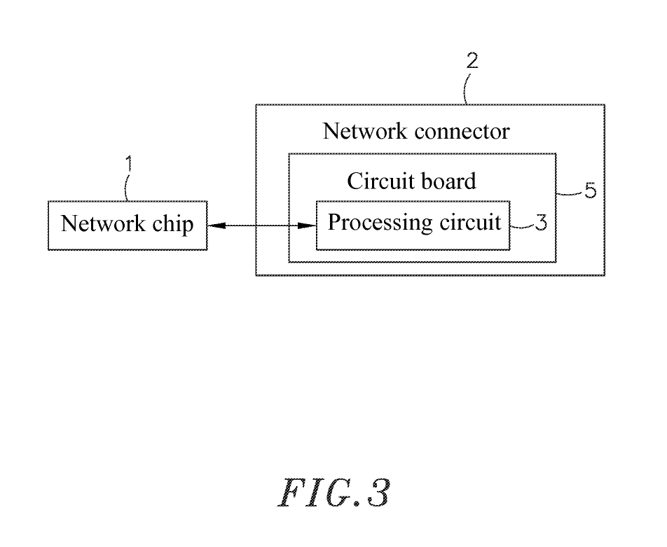

Referring to FIGS. 1-4, a surge protective network signal processing circuit assembly in accordance with the present invention is shown. As illustrated, the surge protective network signal processing circuit assembly comprises a network chip 1, a network connector 2, and a processing circuit 3 connected between the network chip 1 and the network connector 2.

The network chip 1 comprises a set of pins 11 for transmitting electronic/voltage signals. The network connector 2 comprises a set of contacts 21 for transmitting electronic/voltage signals. The processing circuit 3 comprises at least one, for example, four two-wire channels 31 electrically connected in parallel between the set of pins 11 of the network chip 1 and the set of contacts 21 of the network connector 2, a signal coupling capacitor 32 electrically connected to each two-wire channel 31, and a self-coupling AC regulator 4 electrically connected in parallel to each two-wire channel 31 between the network connector 2 and the associating signal coupling capacitor 32. Each self-coupling AC regulator 4 comprises an iron core 41, and a winding 42 wound round the iron core 41. The winding 42 of each self-coupling AC regulator 4 has opposing input end 421 and output end 422 respectively and electrically connected to the two wires of the respective two-wire channel 31. Further, the windings 42 of the self-coupling AC regulators 4 are electrically connected to a ground terminal 43 to form a self-coupling AC regulator loop.

Further, the network chip 1 and the processing circuit 3 can be installed in a circuit board 5, and then electrically connected to the network connector 2 through the circuit board 5. Alternatively, the network connector 2 and the processing circuit 3 can be installed in a circuit board 5, and then electrically connected to the network chip 1 through the circuit board 5. The circuit board 5 provides the network chip 1, the network connector 2 and the processing circuit 3 with the necessary working power supply. Further, the circuit board 5 can be equipped with a power source (such as dry battery, rechargeable battery, lithium-ion battery or button cell), or electrically connected to a city power outlet through a power cable to obtain the necessary working power supply. The arrangement of the network chip 1, the network connector 2 and the processing circuit 3 is of the known technique and not within the scope of the technical features of the present invention, no further detailed description in this regard will be necessary.

Further, the pins 111 of the set of pins 11 of the network chip 1 in the present preferred embodiment are identified as MD0⁺, MD0⁻, MD1⁺, MD1⁻, MD2⁺, MD2⁻, MD3⁺ and MD3⁻. Further, the contacts 211 of the set of contacts 21 of the network connector 2 in the present preferred embodiment are identified as MX0⁺, MX0⁻, MX1⁺, MX1⁻, MX2⁺, MX2⁻, MX3⁺ and MX3⁻. However, this configuration layout is changeable to fit different design requirements.

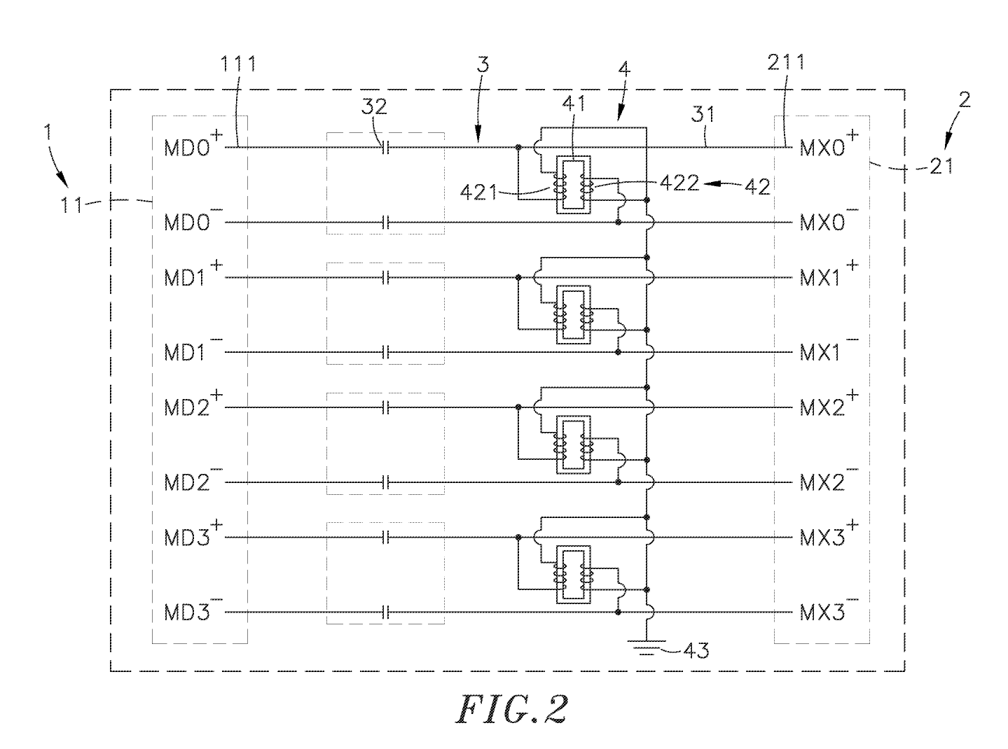

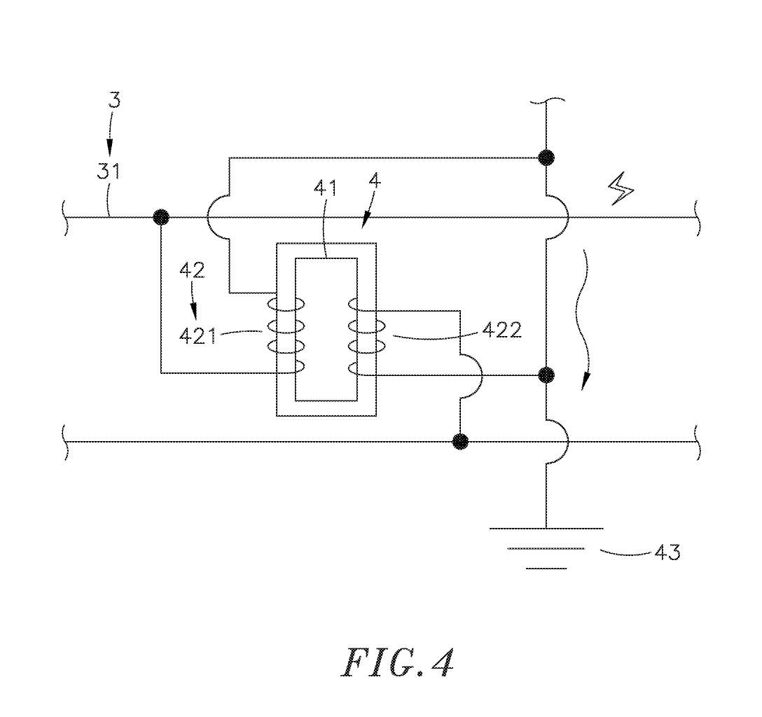

Referring to FIGS. 2 and 4 again, when an instantaneous high voltage occurs upon a lightning spike during transmission of a network signal through the contacts 211 of the set of contacts 21 of the network connector 2, the surge (voltage spike) is transmitted through the network connector 2 to every two-wire channel 31 of the processing circuit 3 and the self-coupling AC regulator 4 in each two-wire channel 31. Subject to the effect of the internal low resistance (about 0.1Ω˜10Ω) in each self-coupling AC regulator 4, each self-coupling AC regulator 4 transmits this instantaneous high voltage (several kilovolts) to the ground terminal 43, avoiding power surge damage. Through a network surge generator test system, surge information can be analyzed and reported.

A conventional resistor-inductor circuit, or RL filter, for use in a network line is capable of removing DC and low frequency noises. Further, a DC or low frequency noise, or a surge, caused by static electricity or lightning, is a low frequency signal of short duration spike in electrical circuits with 1 kHz˜1 MHz frequency and amplitude of several volts. Its rise time in voltage is about 1˜10 μs. The transmission speed of network connectors and high-speed electrical connectors are normally within the range of 10 Mb/s˜1 Gb/s, and the frequencies of the related transmission signals are normally within the range of 2.5 MHz˜125 MHz, i.e., over 1 MHz. Thus, a frequency threshold, for example, 1 MHz, can be set in a high-pass DC filter to remove low frequency signals, enabling any signal of frequency above the set frequency threshold to pass. With respect to the impact of an instantaneous high voltage caused by a lightning, if 10/700μ works with a network surge generator of internal resistance about 15Ω for surge testing subject to IEC 61000-4-5 standard, the external resistance should be equal to about 25Ω. If a 10/100 M network cable is used, each of the four lines has 4 pcs of 100Ω resistors connected thereto in series (4 sets of 100Ω are parallel equivalent, forming the external 25Ω equivalent resistance). For example, when the network surge generator generates 6 KV instantaneous high voltage, it is dropped by the self-coupling AC regulator 4 (DC resistance 1Ω) subject to the formula of:

6 KV/(15+100+1)×1Ω (the resistance of the self-coupling AC regulator 4 in this example is 1Ω)=51.72V.

Thus, the surge (voltage spike) transmitted to the network connector 2 is dropped by the self-coupling AC regulator 4 to the level of 51.72V, and the other large voltage (about 5.95 KV) is discharged by the self-coupling AC regulator 4 through the ground terminal 43, avoiding power surge damage. After processed through the self-coupling AC regulator 4, the voltage level of 51.72V is transmitted to the pins 111 of the set of pins 11 of the network chip 1 without causing any damage (a network line can sustain voltages of several tens to several hundred volts)

Further, the induction capacity of the self-coupling AC regulator 4 can be in the range of 40 μH˜1000 μH to fit different application requirements. If equivalent impedance is about 100 MHz, the resistance of the self-coupling AC regulator 4 can be in the range of 200Ω˜10,000Ω without affecting network signal transmission. Thus, 10 M, 100 M or 1 G signals can pass through the surge protective network signal processing circuit assembly smoothly without interference from the self-coupling AC regulator 4.

As described above, the invention provides a surge protective network signal processing circuit assembly, which comprises a network chip 1, a network connector 2, and a processing circuit 3 connected between the network chip 1 and the network connector 2, wherein the processing circuit 3 comprises at least one, for example, four two-wire channels 31 electrically connected in parallel between pins 111 of the network chip 1 and contacts 211 of the network connector 2, a signal coupling capacitor 32 electrically connected to each two-wire channel 31, and a self-coupling AC regulator 4 electrically connected in parallel to each two-wire channel 31 between the network connector 2 and the associating signal coupling capacitor 32. Further, each self-coupling AC regulator 4 comprises an iron core 41, and a winding 42 wound round the iron core 41. Further, the windings 42 of the self-coupling AC regulators 4 are electrically connected to a ground terminal 43 to form a self-coupling AC regulator loop. Subject to the functioning of the self-coupling AC regulators 4, any instantaneous high voltage can be dropped, avoiding power surge damage.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A surge protective network signal processing circuit assembly, comprising a network chip, a network connector, and a processing circuit connected between said network chip and said network connector, said processing circuit comprises at least one two-wire channel electrically connected in parallel between respective pins of said network chip and respective contacts of said network connector and a signal coupling capacitor electrically connected to each said two-wire channel;
wherein said processing circuit further comprises a self-coupling AC regulator electrically connected in parallel to each said two-wire channel between said network connector and said associating signal coupling capacitor, each said self-coupling AC regulator being electrically connected to a ground terminal for discharging voltage surges.

2. The surge protective network signal processing circuit assembly as claimed in claim 1, wherein each said self-coupling AC regulator comprises an iron core, and a winding wound round said iron core, said winding having two opposing sides respectively electrically connected to the two wires of the respective said two-wire channel.

3. The surge protective network signal processing circuit assembly as claimed in claim 1, wherein each said self-coupling AC regulator comprises an iron core selectively configured in an annular or rectangular shape, and a winding wound round said iron core, said winding having two opposing sides respectively electrically connected to the two wires of the respective said two-wire channel.

4. The surge protective network signal processing circuit assembly as claimed in claim 1, wherein each said self-coupling AC regulator has a predetermined resistance in the range of 0.1Ω˜10Ω.
